(19) United States
(12) Patent Application Publication
(10) Pub. No.: US 2024/0418324 A1
(43) Pub. Date: Dec. 19, 2024

(54) MULTI-STAGE COMPRESSION DEVICE FOR COMPRESSING A GASEOUS MEDIUM, SYSTEM AND FILLING STATION HAVING SAME, AND METHOD FOR MULTI-STAGE COMPRESSION OF A GASEOUS MEDIUM

(71) Applicant: ARGO GMBH, Wesel (DE)

(72) Inventors: Jan ANDREAS, Wesel (DE); Peter CASTENFELT, London (GB)

(21) Appl. No.: 18/712,660

(22) PCT Filed: Nov. 22, 2022
(86) PCT No.: PCT/EP2022/082742

§ 371 Date: May 22, 2024

(30) Foreign Application Priority Data
Nov. 23, 2021 (DE) 10 2021 213 172.7

(51) Int. Cl. F17C 7/00; C25B 1/34; C25B 15/08

(52) U.S. Cl. CPC F17C 7/00; C25B 15/08; C25B 1/34; F17C 2201/0104; F17C 2201/0128; F17C 2201/0166; F17C 2201/052; F17C 2203/0639; F17C 2205/0352; F17C 2221/012; F17C 2225/036; F17C 2227/0135; F17C 2227/0157; F17C 2227/0348; F17C 2265/065

(57) ABSTRACT

A multi-stage compression device, comprising: a first compression stage comprising: two pressure vessels, each being provided with a liquid feeding pipe, via which a working medium A can be introduced into the respective pressure vessel to compress the gaseous medium to a predetermined first pressure P2 by increasing the liquid volume of the working medium A, and the two pressure vessels being able to be supplied with the working medium A by a common liquid pump or two independent liquid pumps, and the working medium A being able to be pumped out of the at least two pressure vessels once the compression process is complete, an intermediate storage tank that is configured to temporarily store the compressed gaseous medium, and a further compression stage which is upstream of the first compression stage and is configured to precompress the supplied gaseous medium.

### TECHNICAL FIELD

The present invention relates to a multi-stage compression device for compressing a gaseous medium, in particular hydrogen. The present invention furthermore relates to a system for providing compressed gaseous hydrogen and to a filling station, in particular a hydrogen filling station, that comprises a multi-stage compression device according to the invention. The present invention also relates to a method for the multi-stage compression of a gaseous medium, in particular using the multi-stage compression device according to the invention.

### PRIOR ART

Conventional filling stations, which serve to refuel vehicles with gasoline and diesel, are well known. Also known are filling stations at which so-called natural gas vehicles are refueled with compressed natural gas that is at a pressure of 400 bar to 1000 bar. Here, the natural gas is mostly stored in underground storage tanks at a pressure of up to 1000 bar and fed to the vehicle to be refueled.

In addition, more and more hydrogen filling stations have been realised in recent years, at which correspondingly modified vehicles or modern fuel cell vehicles can be refueled with gaseous and/or liquid hydrogen. At these filling stations, hereinafter referred to as hydrogen filling stations, the gaseous and/or liquid hydrogen is transferred to the vehicle to be refueled by means of suitable refuelling couplings.

More and more vehicle manufacturers are presenting motor vehicles powered by gaseous fuels such as natural gas, LPG or hydrogen. These include not only passenger cars, but also buses, trucks and forklifts. Parallel to the growing number of vehicles operated with compressed gases, the number of filling stations is also growing, especially the number of hydrogen filling stations. The hydrogen filling stations are more often used by private customers. Owing to the higher pressures and lower temperatures of hydrogen as compared to natural gas or LPG, new developments for refuelling methods and other devices are necessary in particular for refuelling with hydrogen. In addition, however, costs for hydrogen must be kept as low as possible in order to increase acceptance compared to other fuels. This means that the investment costs for filling stations must also be kept low.

Hydrogen filling stations already exist at which the refuelling of vehicles with gaseous hydrogen is realised at pressures of up to 700 bar. In order to be able to refuel several vehicles successively and/or simultaneously, refuelling methods are usually used in which large amounts of pressurised gaseous hydrogen are temporarily stored in corresponding pressure buffers. In addition, the compressor system to be provided must be dimensioned or designed in such a way that the required volume flows can be guaranteed.

Various types of piston or diaphragm compressors are known in the gas industry. In particular piston-driven compressors have the problem that they have a seal or double seal that follows the movement of the piston and is correspondingly subjected to high stress. As soon as the seal leaks, the compressor no longer works and must be overhauled. The losses generated by these leakages are in the range of approximately three percent in piston compressors. This means that 3% of the compressed volume is lost via the seal, which represents a considerable cost factor. Furthermore, it is necessary to detect possible leakages which can pose a danger to the environment if they are not identified. Diaphragm compressors use a large diaphragm instead of a piston. They can only start up at very low pressures and can only generate a small oscillation or stroke. Microcracks in the diaphragm are difficult to detect, which can also result in leakages. Both systems have the problem of fast-moving sealing solutions, which subjects the seals to extreme stress. Repairing these compressors is time consuming because the compressor is in contact with the gas (hydrogen).

Furthermore, piston compressors are usually driven by compressed air or hydraulic oil. Due to the thermal expansion inside the compressor, the gas to be compressed, in particular the hydrogen, heats up and must be cooled, which is extremely energy intensive.

In diaphragm compressors, the heads in which the diaphragms are provided are very heavy, which means that maintenance is very time consuming and the diaphragm compressor requires a lot of space. Specific box solutions must be provided, and the space above the compressor cannot be used since it is required for maintenance. A diaphragm compressor is sensitive and should only be put into operation or started a few times a day (fewer than 3 to 5 times a day), which makes the control of diaphragm compressors extremely inflexible. This is not possible with filling stations having varying refuelling cycles. If diaphragm compressors are only started extremely infrequently, i.e. are operated continuously, they have a long service life. Therefore, diaphragm compressors are usually used in industry where the compressor is operated twenty-four/seven.

Accordingly, the currently known piston and diaphragm compressors can only be used to a limited extent in filling stations, in particular hydrogen filling stations, with varying and short refuelling cycles.

Furthermore, known filling stations that are specifically provided for refuelling vehicles with hydrogen require a lot of cooling energy. For example, the refuelling of passenger cars requires pre-cooling of the gas (hydrogen) in the pump to −40° C. At −40° C., the vehicle can be refueled with a hydrogen quantity of approx. 5 kg within approx. 3 to 5 minutes without overheating the vehicle's tank system.

The vehicles are usually refueled directly by the compressors or form a high-pressure bundle having the ambient temperature. For heavy-duty applications, such as 40-tonne trucks that require more hydrogen, the refuelling flow rate must be increased from 60 grams/second, as is common for passenger cars, for example, to 120 grams/second or even 180 grams/second. This means, however, that the gas or hydrogen would have to be cooled down more and that more cooling energy is required.

As briefly mentioned above, the tightness of the compression apparatus (compressor) is a major problem when compressing gases, especially when compressing hydrogen. Hydrogen is the smallest molecule found on earth, which makes it difficult to ensure the tightness of the compression apparatus and the entire hydrogen filling station. If the system, in particular the compression apparatus, is not tight, there is a great risk in case of leakage. Hydrogen becomes very hot during the known compression by piston or diaphragm compressors, which is why a cooler must be provided which cools the compressed gas (hydrogen). In larger compressors with several stages, the hydrogen must sometimes be re-cooled between the individual compression stages in order to prevent the hydrogen from heating up to critical levels. This makes the compressor stages complicated since additional cooling circuits have to be provided.

Due to the necessary cooling after compression of the gas (hydrogen), the energy consumption of known hydrogen filling stations is extremely high. In the conventional compression of hydrogen, the energy input for cooling the compressed hydrogen is approximately as high as the energy required for the actual compression of the hydrogen.

In order to meet the above-described new requirements regarding the availability of compressed hydrogen, in particular the increased refuelling flow rate, DE 10 2009 039 645 A1 proposes, for example, an arrangement for filling a storage tank with compressed hydrogen, comprising: a) at least one storage container which serves to store the hydrogen in the liquid and/or gaseous state, b) at least one cryogenic pump and/or at least one compressor which serves to compress the hydrogen stored in the storage container, c) at least one high-pressure storage tank which serves to temporarily store the compressed hydrogen, and d) a piping system via which the hydrogen from the storage container and/or the high-pressure storage tank is fed to the storage tank to be filled, with means for cooling and/or heating being assigned to the high-pressure storage tank.

As described in DE 10 2016 009 672 A1, which also teaches a hydrogen filling station, there is the problem of boil-off gas when storing liquid hydrogen. DE 10 2016 009 672 A1 proposes to discharge the boil-off gas of the storage tank and to use it for cooling the pipelines. The production of liquid hydrogen is extremely energy intensive, and the efficiency of such hydrogen filling stations is correspondingly strongly impaired by the boil-off effect. The transport of the liquid hydrogen to the hydrogen filling stations is also extremely complex due to the low temperature of the hydrogen.

In order to reduce the production costs for hydrogen, new possible ways of producing hydrogen have furthermore also been sought in recent years. Chlor-alkali electrolysis, which is well known, is in particular deemed to be a great prospect in this regard since it is already being used in industry on a large scale to produce chlorine and sodium hydroxide, which is produced from sodium chloride and water. However, to date, hydrogen has merely been seen as an annoying by-product of this process, which unnecessarily tightens safety standards, in particular with regard to explosion protection, without so far offering any economic advantage. This is primarily due to the fact that the hydrogen is produced at an extremely low pressure of approx. 1.2 bar when conducting chlor-alkali electrolysis, which until now has necessitated a technically complex and cost-intensive compression of the low-pressure hydrogen into economically viable pressure ranges of 30 bar to 300 bar. The technical challenge here is to be seen in particular as the large volume flows at extremely low pressure levels as well as the high compression ratios of up to 1:300, which cannot be realised in an economical manner with conventional piston compressors or diaphragm compressors.

### DESCRIPTION OF THE INVENTION

In view of the above-described problems in the compression of gaseous media, in particular hydrogen that is at extremely low pressure levels, one object of the present invention is to provide a multi-stage compression device for compressing a gaseous medium, in particular hydrogen, which is capable on the one hand of drastically reducing the energy input required for compressing the gaseous medium and on the other hand of minimising maintenance effort and operating costs, it being at the same time possible to achieve extremely high compression ratios.

The aforementioned object is solved by means of a multi-stage compression device for compressing a gaseous medium according to claim 1, a system for providing compressed gaseous hydrogen according to claim 18, a filling station, in particular a hydrogen filling station, according to claim 20, and a method for the multi-stage compression of a gaseous medium according to claim 21.

Preferred further developments of the invention are specified in the dependent claims, and the subject matters of the filling device and of the filling station can be used in the method for filling at least one storage tank with compressed hydrogen, and vice versa.

One of the basic ideas of the present invention is that a multi-stage compression device for compressing a gaseous medium, in particular gaseous hydrogen, is equipped with at least two compression stages, with at least the first compression stage being configured as a so-called water compressor comprising at least two pressure vessels, each of which is provided with at least one liquid feeding pipe, via which a working medium can be introduced into the respective pressure vessel in order to compress the gaseous medium to be compressed that is in the pressure vessel to a predetermined first pressure P₂ by increasing the liquid volume of the working medium A present in the pressure vessel, and the at least two pressure vessels being able to be supplied with the working medium by a common liquid pump or two independent liquid pumps and the working medium being able to be pumped out of the at least two pressure vessels by the same liquid pump(s) or further liquid pumps once the compression process is complete. The further compression stage, in particular the low-pressure compression stage, is upstream of the first compression stage and serves to compress or precompress the supplied gaseous medium, in particular the gaseous hydrogen.

In this way, the conventional piston or diaphragm compressors described above, which come into direct contact with the hydrogen during compression thereof, can be dispensed with, as a result of which the problems of high susceptibility to leakage as described above and the associated high maintenance effort can be eliminated. Furthermore, by using water as the working medium, contamination (diffusion of foreign atoms) of the hydrogen can be ruled out. Moreover, with the described manner of compressing the hydrogen, the temperature of the hydrogen increases only slightly, which means that the conventional re-cooling of the hydrogen after compression by piston or diaphragm compressors can be dispensed with or at least the energy required herefor can be reduced, as a result of which the energy efficiency of the compression process can be significantly increased. A compression device is furthermore provided in this manner that makes it possible to realise high compression ratios also within an economic framework, in particular for industrial plants.

According to one aspect of the present invention, a multi-stage compression device for compressing a gaseous medium, in particular gaseous hydrogen, comprises:
at least one buffer tank that is configured to temporarily store the gaseous medium to be compressed,
a first compression stage comprising:
   at least two pressure vessels, and
   a piping system for feeding the gaseous medium to be compressed to and discharging the compressed gaseous medium from the at least two pressure vessels,
wherein the at least two pressure vessels are each provided with at least one liquid feeding pipe, via which a working medium, in particular a compression liquid, can be introduced into the respective pressure vessel in order to compress the gaseous medium to be compressed that is in the pressure vessel to a predetermined first pressure by increasing the liquid volume of the working medium present in the pressure vessel, and
wherein the at least two pressure vessels can be supplied with the working medium by a common liquid pump or two independent liquid pumps, and the working medium can be pumped out of the at least two pressure vessels by the same liquid pump(s) or further liquid pumps once the compression process is complete,
at least one intermediate storage tank that is configured to temporarily store the gaseous medium compressed by the first compression stage, and
a further compression stage, in particular a low-pressure compression stage, which is upstream of the first compression stage and is configured to compress the supplied (fed) gaseous medium (to be compressed) preferably in a range of 1:1.5 to 1:3, in particular to a pressure P₁ in the range of 2 bar to 6 bar (absolute pressure),
wherein the first compression stage is preferably configured to pump the working medium from one of the at least two pressure vessels into the other of the at least two pressure vessels once the compression process is complete in order to carry out a further compression process.

In other words, the storage volume available in the pressure vessel for the gaseous medium to be compressed, in particular hydrogen, can be reduced by introducing a working medium, in particular a compression liquid, into the pressure vessel, with part of the working medium possibly already having been present in the pressure vessel, as a result of which the gaseous medium can be compressed to a predetermined or desired first predetermined pressure. Accordingly, the amount of working medium introduced into the pressure vessel determines the change in volume of the storage volume available for the medium to be compressed and thus the compression ratio or increase in pressure of the gaseous medium to be compressed. In order to be able to compress the compressed gaseous medium in the pressure vessel by introducing the working medium, the gaseous medium is preferably enclosed in the pressure vessel by valves.

The buffer tank is preferably arranged upstream of the further compression stage, in particular the low-pressure compression stage, or the first compression stage. If the buffer tank is provided downstream of the further compression stage, it can either be configured to be smaller or a larger amount of gaseous medium to be compressed can be stored thereby.

It is furthermore preferred that the multi-stage compression device comprises a second compression stage downstream of the first compression stage, said second compression stage comprising a compression apparatus that is configured to compress or re-compress the gaseous medium compressed by the first compression stage to a predetermined second pressure.

It can be advantageous here that the multi-stage compression device also comprises a dehumidification device that is configured to dehumidify the gaseous medium, in particular hydrogen, compressed by the first compression stage.

It is furthermore advantageous that the first compression stage is configured to compress the supplied gaseous medium in a range of 1:10 to 1:40, in particular from a pressure P₁ in the range of 1 bar to 2 bar (absolute pressure) to the first predetermined pressure P₂ in the range of 10 bar to 50 bar, in particular 30 bar.

It is also preferred that the second compression stage is configured to compress the gaseous medium precompressed by the first compression stage in a range of 1:10 to 1:100, in particular from the first predetermined pressure P₂ to the second predetermined pressure P₃ in the range of 100 bar to 1000 bar, in particular 300 bar to 500 bar.

According to a further embodiment, the at least two pressure vessels of the first compression stage are configured as steel vessels, in particular steel vessels made of PN40, and preferably have a capacity of 5,000 litres to 100,000 litres, preferably of 20,000 litres to 60,000 litres.

It is furthermore preferred that the at least two pressure vessels of the first compression stage are configured as spherical tanks, cylindrical tanks or tubular tanks.

It is also advantageous that the further compression stage, in particular the low-pressure compression stage, is configured as a radial compressor, blower/fan compressor, screw compressor, turbo compressor or gas turbine compressor.

The further compression stage can also be driven by the flow energy of the working medium of the first compression stage. For this purpose, an impeller or turbine wheel can be inserted into the liquid feeding pipe or a liquid discharging pipe of the first compression stage that serve to circulate the working medium, which impeller or turbine wheel uses some of the kinetic energy of the flowing working medium, in particular at the outlet of one of the two pressure vessels, to generate electrical energy that is used to drive the further compression stage or uses the absorbed kinetic energy directly to mechanically drive the further compression stage.

According to a further embodiment of the present invention, the working medium is a liquid in which the gaseous medium to be compressed does not dissolve and/or which can be separated from the gaseous medium without leaving any residue, the working medium preferably being water.

It is furthermore advantageous that the first and the further and preferably also the second compression stages are each configured such that they can perform a compression process within 5 minutes to 15 minutes, preferably 10 minutes. For this purpose, in particular the pumps used must be configured such that they can feed the working medium required for compression into the respective pressure vessel within the required time.

It can furthermore be advantageous, in particular in the case that the second compression stage is dispensed with and a vehicle to be filled is refueled directly from the first compression stage, that during the refuelling process, working medium is continuously pumped into the respective pressure vessel so that the pressure in the respective pressure vessel can be kept constant.

It can be advantageous here to form the at least one intermediate storage tank from a plurality of intermediate storage tanks formed from a multi-layer laminate high-pressure vessel, in particular a carbon fibre high-pressure vessel.

It is furthermore preferred to configure the second compression stage, in particular the compression apparatus, as a water compressor like the first compression stage, as a piston compressor, or as a simple pump.

According to a further embodiment of the present invention, at least the first compression stage, preferably also the second compression stage, is provided with a cooling device that is configured to cool the working medium, in particular the compression liquid, to a predetermined temperature T1, in particular to a temperature in the range of 1° C. to 5° C., preferably 1° C., in particular before it is introduced into the respective pressure vessel.

It is also advantageous that the first compression stage comprises at least one storage tank or reservoir, in which the working medium, in particular the water, can be temporarily stored.

It can furthermore be advantageous that the one common liquid pump or two independent liquid pumps of the first compression stage is/are configured to feed the working medium having the first predetermined pressure P₂ in a range of 10 bar to 50 bar to the at least two pressure vessels.

It is additionally preferred that the multi-stage compression device also comprises at least one high-pressure storage tank that is configured to temporarily store the gaseous medium compressed by the second compression stage, in particular the compressed hydrogen, at a pressure of up to 1000 bar, the at least one high-pressure storage tank preferably being divided into a plurality of storage segments that can preferably be filled and/or emptied independently of one another.

The present invention furthermore relates to a system for providing compressed gaseous hydrogen that is preferably used for refuelling vehicles, comprising:
at least one electrolyser, in particular a chlor-alkali electrolyser, that is preferably configured to produce hydrogen at an output pressure of 1 bar to 3 bar (absolute pressure), and
the multi-stage compression device described above,
wherein the multi-stage compression device is configured to process, in particular compress, the gaseous hydrogen produced by the at least one electrolyser for subsequent use.

Furthermore, in the context of the present invention, the terms “vehicle” or “means of transport” or other similar terms as used below include motor vehicles in general, such as passenger automobiles including sports utility vehicles (SUVs), buses, trucks, various commercial vehicles, water vehicles including various boats and ships, aircraft, aerial drones and the like, hybrid vehicles, electric vehicles, plug-in hybrid electric vehicles, hydrogen vehicles and other alternative vehicles. As stated herein, hybrid vehicles are vehicles having two or more energy sources, e.g. gasoline-powered and simultaneously electric-powered vehicles.

It is furthermore advantageous that the system also comprises a distribution device (dispenser), which is preferably provided with a temperature control device, by means of which the hydrogen fed or to be fed to a vehicle or storage tank can be conditioned to the individual existing framework conditions, the hydrogen preferably being fed to the vehicle or the storage tank at a pressure of between 350 bar and 700 bar and at a temperature of −33° C. to −40° C. For this purpose, the chiller required for cooling can simultaneously also take on the function of dehumidification and thus bring the dew point of the compressed gas to −40° C., for example. This prevents reconversion of the water in the gas upon removal in the vehicle.

The present invention furthermore relates to a filling station, in particular a hydrogen filling station, for refuelling a vehicle with compressed hydrogen, comprising:
at least one refuelling device that is preferably configured to correspond to corresponding reception devices provided in the vehicles to be refueled, and
the multi-stage compression device according to the invention as described above.

It is furthermore advantageous if the filling station additionally comprises a hydrogen storage unit and/or a quick coupling, by means of which a mobile hydrogen storage unit can be connected with the filling device in a fluid-conducting manner, wherein gaseous hydrogen can be stored in the hydrogen storage unit and/or the mobile hydrogen storage unit at a pressure of 1 bar to 500 bar and can be compressed by the compression apparatus of the filling device to a pressure of up to 1000 bar for temporary storage in the high-pressure storage tank.

It is also advantageous if the filling station, in particular a control device, is configured to exchange information via a cloud-based server and/or a mobile app with clients, in particular vehicles to be refueled, about their refuelling requirements such as refuelling amount, refuelling temperature, refuelling pressure, refuelling speed (grams/second), refuelling time and the like and to accordingly determine or create at least one refuelling profile and/or refuelling prediction based on the exchanged information.

The present invention furthermore relates to a method for the multi-stage compression of a gaseous medium, in particular hydrogen, comprising the steps of:
a) Introducing the gaseous medium to be compressed into a first of at least two pressure vessels of a first compression stage, into which a working medium A, in particular a compression liquid, can be introduced,
b) Compressing the gaseous medium to be compressed by introducing the working medium A into the first of at least two pressure vessels or by increasing the liquid volume of the working medium A inside the pressure vessel to a predetermined first pressure P₂,
wherein before being introduced into the first compression stage, the gaseous medium to be compressed is precompressed in a range of 1:1.5 to 1:3, in particular to a pressure P₁ in the range of 2 bar to 6 bar (absolute pressure), by a further compression stage, in particular a low-pressure compression stage, upstream of the first compression stage.

It is furthermore advantageous that the method comprises the steps of:
c) Temporarily storing the gaseous medium compressed to the predetermined first pressure P₂ in an intermediate storage tank,
d) Feeding the compressed gaseous medium to a compression apparatus of a second compression stage, and
e) Compressing the gaseous medium compressed by the first compression stage to a predetermined second pressure P₃.

It is also advantageous that the working medium A, in particular the compression liquid, introduced into the at least first of the at least two pressure vessels is cooled before being introduced or fed in, in particular to a temperature in the range of 1° C. to 5° C., in particular to a temperature of 1° C., in order to passively cool the gaseous medium to be compressed, in particular hydrogen, during compression thereof by contact with the working medium A.

It is furthermore advantageous that during compression of the gaseous medium to be compressed, a filling level of the working medium A (in one of the at least two pressure vessels) is raised from a minimum filling level Hₘᵢₙ to a predetermined filling level H_{target}, thereby increasing the pressure of the gaseous medium to be compressed to the first predetermined pressure P₂ or target value.

According to a further embodiment of the present invention, the method further comprises the following steps:
f) Lowering the filling level of the working medium in one of the at least two pressure vessels, in particular back to the minimum filling level Hₘᵢₙ,
g) Temporarily storing the discharged working medium A in a reservoir or introducing the working medium A into the other of the at least two pressure vessels in order to carry out a further compression process there.

It is also preferred for the method to additionally comprise the following steps:
h) Pressurising the working medium A to an operating pressure P₂ of up to 100 bar, preferably by means of a high-pressure pump,
i) Cooling or re-cooling the working medium A set to operating pressure P₂, and
j) Feeding the working medium set to operating pressure to one of the at least two pressure vessels, as a result of which the gaseous medium to be compressed, which is introduced into the pressure vessel in step a), is compressed to the first predetermined pressure P₂.

It is furthermore advantageous that the gaseous medium to be compressed is hydrogen, which is produced by chlor-alkali electrolysis upstream of the multi-stage compression process, and the hydrogen produced by chlor-alkali electrolysis preferably leaves the electrolysis process at a pressure in the range of 1 bar to 3 bar (absolute pressure), preferably 1.2 bar.

The multi-stage compression device for compressing a gaseous medium can be integrated into the described system for providing compressed gaseous hydrogen as well as into the described filling station, in particular the hydrogen filling station. The described multi-stage compression device can furthermore be used in the described method for the multi-stage compression of a gaseous medium. The further features disclosed in connection with the multi-stage compression device can therefore also be applied to the system and the filling station as well as to the method. The same applies vice versa for the refilling station as well as the method.

### BRIEF DESCRIPTION OF THE FIGURES

Further features and advantages of a device, a use and/or a method are apparent from the following description of embodiments with reference to the accompanying figures. In these figures:

FIG. 1 schematically shows a known refuelling device according to the prior art,

FIG. 2 shows, in a simplified manner, the basic principle of a first compression stage according to the invention,

FIG. 3 shows, in a simplified manner, an embodiment of a multi-stage compression device according to the invention, and

FIG. 4 schematically shows a hydrogen filling station according to an embodiment of the present invention.

### DESCRIPTION OF EMBODIMENTS

Identical reference numbers used in different figures designate identical, corresponding or functionally similar elements.

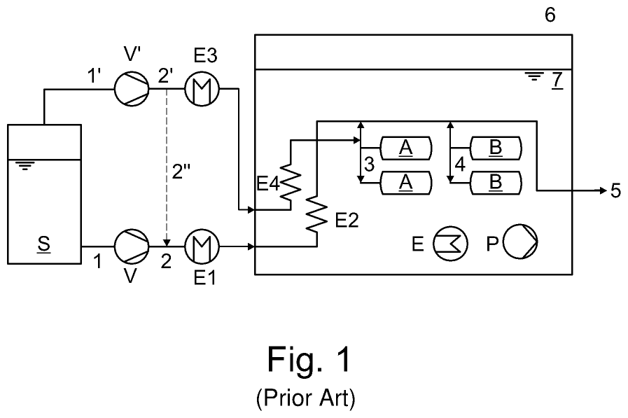

FIG. 1 schematically shows a known refuelling device according to the prior art. FIG. 1 shows a storage container S for liquefied hydrogen, which has a storage volume of between 10 and 200 m³ of hydrogen. Such storage tanks for liquefied hydrogen are sufficiently known from the prior art. In the context of hydrogen filling stations, they are preferably located underground and can be driven over by the vehicles to be refueled.

A cryogenic pump V and a compressor V′ are also provided. The cryogenic pump V is supplied with liquid hydrogen from the storage container S via the pipe 1, which is preferably configured so as to be vacuum insulated. The cryogenic pumps V used in practice are specifically designed to meet the requirements present when refuelling vehicles. They offer the possibility of compressing liquid hydrogen from approx. 1 bar to up to 900 bar in a two-stage compression process. Gaseous hydrogen can be drawn off from the storage container S via the pipe 1′ and compressed to a pressure of between 100 and 700 bar by means of the compressor or compression unit V′.

In addition to the storage container S, several high-pressure storage tanks A and B are provided. In practice, these are usually combined into storage banks covering at least three different pressure ranges. For instance, the high-pressure storage tanks A are designed for a storage pressure of between 400 and 700 bar, while the high-pressure storage tanks B are designed for a storage pressure of between 300 and 500 bar. As a rule, additional storage tanks are provided which are designed, for example, for a storage pressure of between 50 and 400 bar. However, methods in which only one or two storage banks or even only one or two high-pressure storage tanks are provided can also be realised.

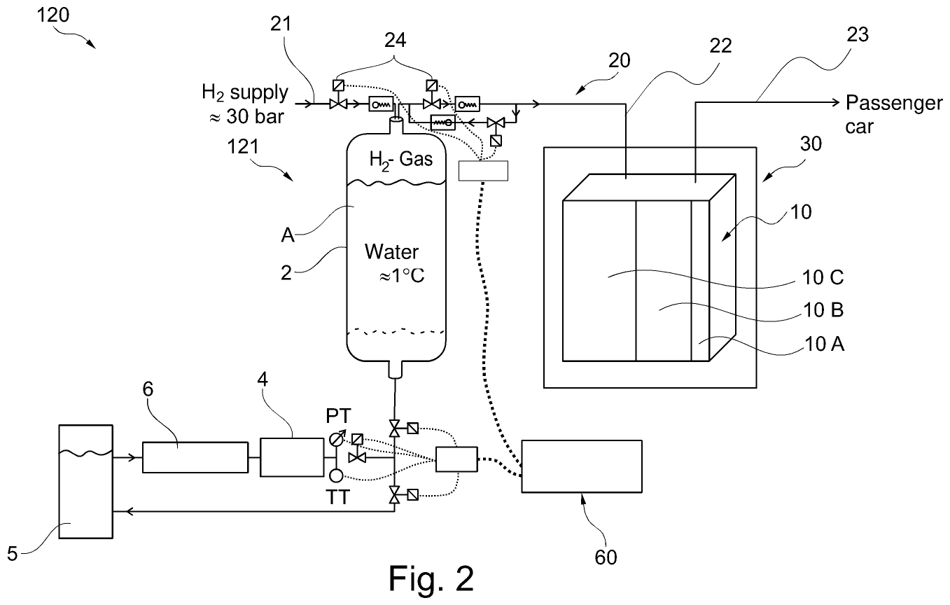

FIG. 2 shows, in a simplified manner, the basic principle of an embodiment of a first compression stage 120 according to the invention. As is apparent from FIG. 2, the first compression stage 120 comprises a pressure vessel 121 for compressing the hydrogen, and this vessel can be supplied, via a hydrogen feeding pipe 21, with gaseous hydrogen to be compressed from, for example, an underground storage tank (buffer tank 1) (not shown). In order to compress the hydrogen, a compression liquid (working medium A) is introduced into the pressure vessel 121, in particular is pumped into the pressure vessel 121 under pressure. In an introduction step, when the gaseous hydrogen is introduced into the unpressurised pressure vessel 121 via the hydrogen feeding pipe 21, the compression liquid is at the filling level marked Hₘᵢₙ. In other words, the pressure vessel 121 is almost empty and ready to receive the hydrogen to be compressed.

When the tank 121 is completely filled with the hydrogen to be compressed, the pressure vessel 121 is closed off via shut-off valves 24, which means that the introduced hydrogen to be compressed cannot escape. A compression device 6, in particular a liquid pump (high-pressure pump), then introduces the compression liquid having a predetermined pressure into the pressure vessel 121 from below via a liquid feeding pipe 123, as a result of which the filling level of the compression liquid (working medium A) in the pressure vessel 121 slowly increases and the hydrogen trapped therein is compressed. When the filling level of the compression liquid in the pressure vessel 121 reaches the target filling level H_{target}, the compression process is complete and the hydrogen has been compressed to the desired pressure.

In order to actively cool the compression liquid (working medium), the shown first compression stage 120 is provided with a cooling device 4 which can, for example, cool the compression liquid (wording medium A), which is preferably water, to a temperature of approx. 1° C.; in this way, during compression of the hydrogen, it is passively cooled by contact with the compression liquid, which makes a downstream re-cooling of the hydrogen obsolete or at least simplifies it.

The shown first compression stage 120 furthermore comprises a storage tank (reservoir) 5 in which the compression liquid (working medium A) cooled by the cooling device can be temporarily stored after the pressure vessel 121 has been emptied and before a new compression process, as a result of which the cooling work of the cooling device 4 can be reduced. Furthermore, a pressure sensor PT and a temperature sensor TT are provided downstream of the cooling device 4, which are connected to a control device 60 and thus enable the control device 60 to control the compression device 6 and the cooling device 4 in such a way that the compression liquid (working medium A) can be introduced into the pressure vessel 121 at a desired temperature and at a desired pressure.

After completion of the compression process, an outlet valve of the shut-off valves 24 is opened and the compressed gaseous hydrogen is conducted via a fluid pipe 22 to a high-pressure storage tank 10 where the compressed (gaseous) hydrogen can be temporarily stored at a pressure of up to 1000 bar until it is conducted via a refuelling pipe 23 to a vehicle to be filled. The high-pressure storage tank 10 shown here comprises a plurality of storage segments 10A to 10C which can be filled with compressed hydrogen independently of one another. The hydrogen stored therein under high pressure can also be removed individually from these storage segments 10A to 10C; in this way, it can be ensured that in the event of a large withdrawal of hydrogen, for example when filling/refuelling a truck, the individual storage segment 10A to 10C is not cooled down too much. Furthermore, the individual segments can each be filled with different pressure levels, as a result of which the compression effort required for hydrogen, which, for example, is only refueled at 300 bar (e.g. trucks), can be reduced.

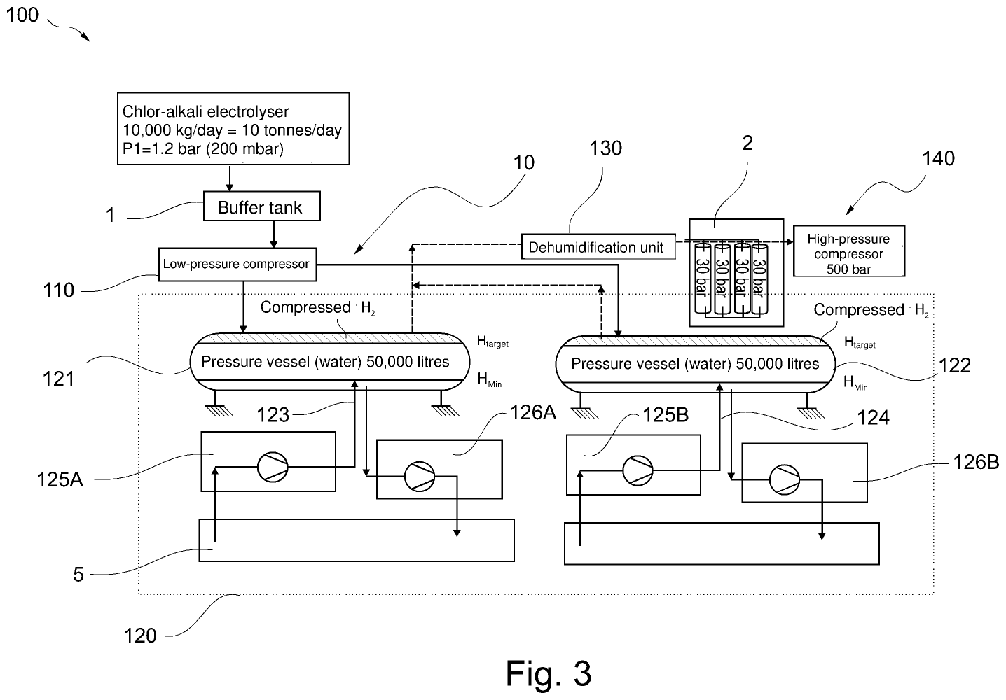

FIG. 3 shows, in simplified form, an embodiment of a multi-stage compression device 100 according to the invention. As is apparent from FIG. 3, the shown multi-stage compression device 100 comprises a buffer tank 1, a first compression stage 120, a further compression stage 110 and a second compression stage 140, which are arranged or connected in series in this order in the direction of flow or feed direction of the gaseous hydrogen to be compressed. Buffer tank 1 is used to temporarily store the gaseous hydrogen (gaseous medium) to be compressed. As a result hereof, fluctuations in the production or supply of hydrogen from the upstream process, such as chlor-alkali electrolysis, can be dampened and a controlled compression process can be ensured by the multi-stage compression device 100.

In the present embodiment, the further compression stage 110, in particular the low-pressure compression stage, is disposed between the buffer tank 1 and the first compression stage 120 and serves to compress the gaseous hydrogen temporarily stored in the buffer tank 1 at a very low pressure of, for example, 1.2 bar (absolute pressure) to a pressure of 2 to 6 bar, as a result of which the necessary compression ratio of the downstream first and second compression stages can be reduced.

The first compression stage 120 of the shown embodiment comprises two pressure vessels 121, 122, as already described above in connection with FIG. 2, each of which is provided with a liquid feeding pipe 123, 124, via which the working medium A, in particular water, can be introduced into the respective pressure vessel 121, 122. The pressure vessels 121, 122 shown here each have a capacity of 50,000 litres. In the shown embodiment, the two pressure vessels 121, 122 are each equipped with their own liquid pump 125A, 125B, which serves to pump the working medium having the desired first pressure P₂ into the corresponding pressure vessel 121, 122 via the respective liquid feeding pipe 123, 124, thereby compressing the hydrogen introduced into and confined in the pressure vessels 121, 122. In the shown embodiment, the two pressure vessels 121, 122 are also each equipped with their own liquid pump 126A, 126B, which serves to pump the working medium A out of the pressure vessels 121, 122 once the compression process is complete. The provision of two separate liquid pumps for pumping the working medium A in and out has the advantage that the liquid pumps 125A, 125B can be configured as high-pressure pumps with a high flow rate and simultaneously a high operating pressure of up to 100 bar, whereas the liquid pumps 126A, 126B, which do not have to be able to generate a high pressure, can be optimised for a high flow rate, as a result of which the cycle time for a compression process can be reduced. The working medium pumped out by the two liquid pumps 126A, 126B is stored in a storage tank 5 or reservoir and made available for a further compression process. If necessary, the stored working medium A in the storage tank 5 or reservoir can be actively or passively cooled.

The hydrogen compressed by the first compression stage 120 to a pressure of 10 bar to 50 bar is fed via a dehumidification device 130 to the intermediate storage tank 2, in which the hydrogen is temporarily stored at a pressure of 10 bar to 50 bar. The hydrogen temporarily stored here can then either be removed and used for low-pressure applications or further compressed via the downstream second compression stage 140, in particular to a pressure in the range of 100 bar to 1000 bar. This further compressed hydrogen can then either be temporarily stored again by a high-pressure storage tank (not shown) or fed directly to a vehicle or storage tank. As already described above, it is expedient to also configure the second compression stage 140, like the first compression stage 120, as a so-called water compressor (same or similar design to the first compression stage).

The working medium used in the first compression stage 120, which is already under pressure, can be used here for a further compression process in the second (other) pressure vessel of the first compression stage 120 or for a downstream compression process in a pressure vessel of the second compression stage 140. In this way, the energy required to pump the first vessel empty can be at least partially used for a subsequent further compression process, which can further increase the efficiency of the multi-stage compression device.

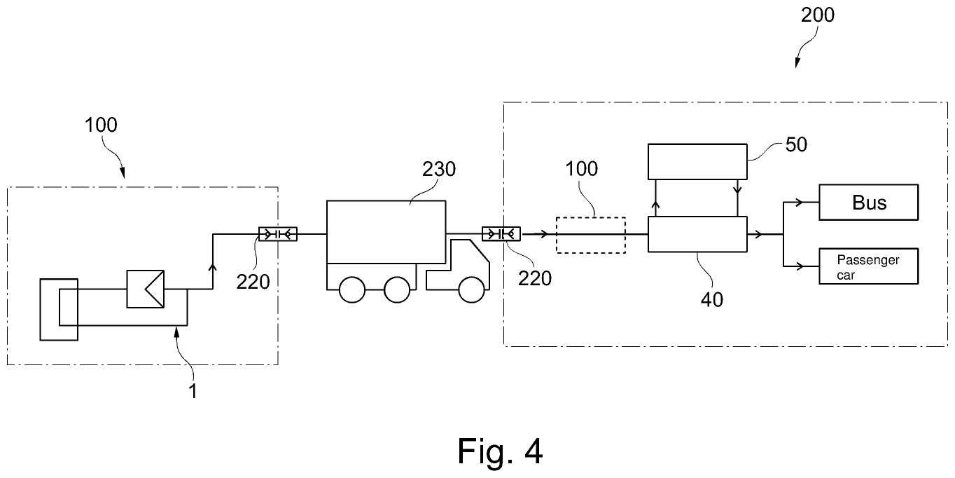

FIG. 4 further shows, in a simplified manner, an embodiment of a filling station 200 according to the invention with a mobile hydrogen storage unit 230. Shown, purely schematically, on the left-hand side of FIG. 4 is a multi-stage compression device 100 according to the invention which can, for example, be set up at a location where the hydrogen is produced, for example at a wind farm or at a chemical plant for the production of chlorine, hydrogen and sodium hydroxide by means of chlor-alkali electrolysis. In the case of a wind farm, the electricity generated there by wind power can be efficiently used to produce hydrogen, especially at times when there is a surplus of electricity in the power grid. In the case of a chemical plant for the production of chlorine, hydrogen and sodium hydroxide, the hydrogen produced there mainly as a by-product can, similar to the hydrogen produced in an environmentally-friendly manner by the wind farm, be compressed cost-effectively via the multi-stage compression device 100 according to the invention to a desired pressure of, for example, 700 bar to 1000 bar and can be temporarily stored in a mobile hydrogen storage unit 210, which can, for example, be integrated in a truck body or can be interchangeably accommodated by a truck. The truck can then transport the mobile hydrogen storage unit 210 to a filling station 200, where it can be connected to a refuelling system of the filling station via a quick coupling 220.

The filling station 200 shown in FIG. 4 has a distribution device 40 (dispenser), which is provided with a temperature control device 50, in particular a cooling device. In this way, the hydrogen can be conditioned during filling of a storage tank of a vehicle, in this case a bus or a passenger car, for example. In other words, the temperature as well as the pressure of the hydrogen fed to the vehicle are controlled and relaxed in such a way that the parameters of the hydrogen meet the requirements of the vehicle. The filling station 200 may optionally also be provided with a multi-stage compression device 100 according to the invention, by means of which the hydrogen removed from the mobile hydrogen storage unit 230 can be compressed again, if necessary.

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. A multi-stage compression device for compressing a gaseous medium, comprising:
at least one buffer tank that is configured to temporarily store the gaseous medium to be compressed,
a first compression stage comprising:
at least two pressure vessels, and
a piping system for feeding the gaseous medium to be compressed to and discharging the compressed gaseous medium from the at least two pressure vessels,
wherein the at least two pressure vessels are each provided with at least one liquid feeding pipe, via which a working medium (A) can be introduced into the respective pressure vessel in order to compress the gaseous medium to be compressed that is in the pressure vessel to a predetermined first pressure (P2) by increasing the liquid volume of the working medium (A) present in the pressure vessel, and
wherein the at least two pressure vessels can be supplied with the working medium (A) by a common liquid pump or two independent liquid pumps, and the working medium (A) can be pumped out of the at least two pressure vessels by the same liquid pump(s) or further liquid pumps once the compression process is complete,
at least one intermediate storage tank that is configured to temporarily store the gaseous medium compressed by the first compression stage, and
a further compression stage, in particular a low-pressure compression stage, which is upstream of the first compression stage and is configured to compress the supplied gaseous medium in a range of 1:1.5 to 1:3,
wherein the first compression stage is configured to pump the working medium (A) from one of the at least two pressure vessels into the other of the at least two pressure vessels once the compression process is complete in order to carry out a further compression process.

2. The multi-stage compression device according to claim 1, further comprising a second compression stage downstream of the first compression stage, said second compression stage comprising:
a compression apparatus that is configured to compress the gaseous medium compressed by the first compression stage to a predetermined second pressure (P3).

3. The multi-stage compression device according to claim 2, wherein the second compression stage is configured to compress the gaseous medium precompressed by the first compression stage in a range of 1:10 to 1:100.

4. The multi-stage compression device according to claim 1, further comprising a dehumidification device that is configured to dehumidify the gaseous medium compressed by the first compression stage.

5. The multi-stage compression device according to claim 1, wherein the first compression stage is configured to compress the supplied gaseous medium in a range of 1:10 to 1:40.

6. The multi-stage compression device according to claim 1, wherein the at least two pressure vessels of the first compression stage are configured as steel vessels.

7. The multi-stage compression device according to claim 1, wherein the at least two pressure vessels of the first compression stage are configured as spherical tanks, cylindrical tanks or tubular tanks.

8. The multi-stage compression device according to claim 1, wherein the further compression stage is configured as a radial compressor, blower/fan compressor, screw compressor, turbo compressor or gas turbine compressor.

9. The multi-stage compression device according to claim 8, wherein the further compression stage is driven by the flow energy of the working medium (A) of the first compression stage.

10. The multi-stage compression device according to claim 1, wherein the working medium (A) is a liquid in which the gaseous medium to be compressed does not dissolve and/or which can be separated from the gaseous medium without leaving any residue.

11. The multi-stage compression device according to claim 1, wherein the first and the further compression stages are each configured such that they can perform a compression process within 5 minutes to 15 minutes.

12. The multi-stage compression device according to claim 1, wherein the at least one intermediate storage tank comprises a plurality of intermediate storage tanks formed from a multi-layer laminate high-pressure vessel.

13. The multi-stage compression device according to claim 1, wherein the second compression stage is configured as a water compressor like the first compression stage, as a piston compressor, or as a simple pump.

14. The multi-stage compression device according to claim 1, wherein at least the first compression stage comprises a cooling device that is configured to cool the working medium (A) to a predetermined temperature (T1).

15. The multi-stage compression device according to claim 1, wherein the first compression stage comprises at least one storage tank or reservoir, in which the working medium (A) can be temporarily stored.

16. The multi-stage compression device according to claim 1, wherein the one common liquid pump or two independent liquid pumps of the first compression stage is/are configured to feed the working medium (A) having the first predetermined pressure (P1) in a range of 10 bar to 50 bar to the at least two pressure vessels.

17. The multi-stage compression device according to claim 1, further comprising at least one high-pressure storage tank that is configured to temporarily store the gaseous medium compressed by the second compression stage at a pressure of up to 1000 bar, wherein the at least one high-pressure storage tank is divided into a plurality of storage segments that can be filled and/or emptied independently of one another.

18. A system for providing compressed gaseous hydrogen for refueling vehicles, comprising:
at least one electrolyser configured to produce hydrogen at an output pressure of 1 bar to 3 bar, and
the multi-stage compression device according to claim 1,
wherein the multi-stage compression device is configured to process the gaseous hydrogen produced by the at least one electrolyser for subsequent use.

19. The system according to claim 18, further comprising a distribution device by means of which the hydrogen to be fed to a vehicle or a storage tank can be conditioned to individual existing framework conditions, the hydrogen being fed to the vehicle or storage container at a pressure of between 350 bar and 700 bar and a temperature of 33° C. to −40° C.

20. A filling station for refueling a vehicle with compressed hydrogen, comprising:
at least one refueling device that is configured to correspond to corresponding reception devices provided in the vehicles to be refueled, and
the multi-stage compression device according to claim 1.

21. A method for the multi-stage compression of a gaseous medium comprising the steps of:
a) introducing the gaseous medium to be compressed into a first of at least two pressure vessels of a first compression stage, into which a working medium (A) can be introduced,
b) compressing the gaseous medium to be compressed by introducing the working medium (A) into the first of at least two pressure vessels or by increasing the liquid volume of the working medium (A) inside the pressure vessel to a predetermined first pressure (P2),
wherein before being introduced into the first compression stage, the gaseous medium to be compressed is precompressed in a range of 1:1.5 to 1:3 by a further compression stage upstream of the first compression stage.

22. The method according to claim 21, further comprising the steps of:
c) temporarily storing the gaseous medium compressed to the predetermined first pressure (P2) in an intermediate storage tank,
d) feeding the compressed, gaseous medium to a compression apparatus of a second compression stage, and
e) compressing the gaseous medium compressed by the first compression stage to a predetermined second pressure (P3).

23. The method according to claim 21, in which the working medium (A) introduced into the at least first of the at least two pressure vessels is furthermore cooled before being introduced or fed in in order to passively cool the gaseous medium to be compressed during compression by contact with the working medium (A).

24. The method according to claim 21, wherein during compression of the gaseous medium to be compressed in one of the at least two pressure vessels, a filling level of the working medium (A) is raised from a minimum filling level (Hmin) to a predetermined filling level (Htarget), thereby increasing the pressure of the gaseous medium to be compressed to the first predetermined pressure (P2) or target value.

25. The method according to claim 21, further comprising the steps of:
f) lowering the filling level of the working medium in one of the at least two pressure vessels,
g) temporarily storing the discharged working medium (A) in a reservoir or introducing the working medium (A) into the other of the at least two pressure vessels in order to carry out a further compression process there.

26. The method according to claim 25, further comprising the steps of:
h) pressurizing the working medium (A) to an operating pressure (P2) of up to 100 bar,
i) cooling or re-cooling the working medium (A) set to operating pressure (P2), and
j) feeding the working medium set to operating pressure to one of the at least two pressure vessels, as a result of which the gaseous medium to be compressed, which is introduced into the pressure vessel in step a), is compressed to the first predetermined pressure (P2).

27. The method according to claim 21, wherein the gaseous medium to be compressed is hydrogen, which is produced by chlor-alkali electrolysis upstream of the multi-stage compression process, and the hydrogen produced by the chlor-alkali electrolysis leaves the electrolysis process at a pressure in the range of 1 bar to 2 bar.
